(19) United States
(12) Patent Application Publication
(10) Pub. No.: US 2014/0022691 A1
(43) Pub. Date: Jan. 23, 2014

(54) MULTILAYERED CERAMIC ELECTRONIC COMPONENT AND MANUFACTURING METHOD OF THE SAME

(71) Applicant: SAMSUNG ELECTRO-MECHANICS CO., LTD., Suwon (KR)

(72) Inventors: Joon Hwan KWAG, Gyunggi-do (KR); Sang Huk KIM, Gyunggi-do (KR)

(73) Assignee: SAMSUNG ELECTRO-MECHANICS CO., LTD., Suwon (KR)

(21) Appl. No.: 13/784,585

(22) Filed: Mar. 4, 2013

(30) Foreign Application Priority Data
Jul. 19, 2012 (KR) 10-2012-0078849

(51) Int. Cl. H01G 4/30

(52) U.S. Cl. CPC H01G 4/30
USPC 361/301.4; 29/25.02

(57) ABSTRACT

There is provided a multilayered ceramic electronic component including: a ceramic body in which a plurality of dielectric layers are multilayered; a plurality of first and second internal electrode layers formed on at least one surfaces of the dielectric layers and alternately exposed through both ends of the ceramic body in a length direction thereof; first and second adhesive layers formed on both ends of the ceramic body, electrically connected the exposed first and second internal electrodes and formed of a conductive paste; and first and second external electrode layers formed on surfaces of the first and second adhesive layers and formed of a glass-free conductive paste.

### CROSS-REFERENCE TO RELATED APPLICATIONS

This application claims the priority of Korean Patent Application No. 10-2012-0078849 filed on Jul. 19, 2012, in the Korean Intellectual Property Office, the disclosure of which is incorporated herein by reference.

### BACKGROUND OF THE INVENTION

1. Field of the Invention

The present invention relates to a multilayered ceramic electronic component and a manufacturing method of the same.

2. Description of the Related Art

As examples of electronic components using a ceramic material, there may be provided a capacitor, an inductor, a piezoelectric element, a varistor, a thermistor, and the like.

Among the ceramic electronic components, a multilayered ceramic capacitor (MLCC) has a small size and high capacity secured therein, and is easily mounted.

A multilayered ceramic capacitor, a chip condenser having a chip shape, is installed in circuit boards of various electronic products including a display device such as a liquid crystal display (LCD), a plasma display panel (PDP), or the like, a computer, a personal digital assistant (PDA), a cellular phone, and the like, to be charged with or discharge electricity.

Due to the recent trend for large-sized display devices, a central processing unit (CPU) therein is increased in terms of a speed, and the like, and so heat generation becomes a serious concern.

Therefore, it is necessary for stable capacitance to be secured in the multilayered ceramic capacitor at high temperatures and with a high degree of reliability, so that an integrated circuit IC installed in the electronic device may be stably operated.

The multilayered ceramic capacitor may be manufactured by forming a multilayered body in which a ceramic dielectric layer and an internal electrode layer are alternately multilayered, firing the multilayered body, and forming external electrodes on both ends thereof.

In order to form the external electrodes of the related art, a metal powder such as copper powder, or the like, is used as the conductive powder, the conductive powder is mixed with a glass frit, a base resin, an organic vehicle produced in an organic solvent, or the like, to produce a conductive paste. Next, the external electrode paste is coated on both ends of a ceramic body, and then the ceramic body on which the external electrode paste is coated is fired to thereby sinter metal powders in the external electrode paste.

Then, in order to be mounted on PCB, or the like, a nickel/tin (Ni/Sn) solder layer may be formed on a surface of the external electrode, using a plating method.

In the conductive paste, the glass frit serves to accelerate a copper powder sintering process, and act as an adhesive agent between the ceramic body and the external electrode, to thereby implement a hermetic sealing by filling an empty space thereof with glass, the empty space being a space not filled by the sintered copper powder.

However, at the time of forming two or more kinds of solder layers for mounting on PCB, or the like, the glass has a lower wetting level than that of copper, resulting in a solder layer having a non-uniform shape being formed.

In addition, a separation phenomenon, or cracks, and the like, may occur due to the above-described phenomenon, at the time of being mounted on a PCB, such that a plating solution may be permeated therethrough to deteriorate reliability and increase a plating time.

Meanwhile, in order to solve this problem, in the case in which glass material is removed from the surface of the external electrode or an added amount thereof is decreased, adhesive force between the ceramic body and the external electrode itself is offset, such that the shapes thereof are not maintained to be uniform, or the adhesive force therebetween is deteriorated, such that reliability may be degraded.

The following Related Art Documents disclose multilayered ceramic capacitors. However, in the following Related Art Documents, Patent Document 1 does not disclose that first and second conductive layers are glass-free. In addition, since Patent Document 2 discloses a first external electrode including glass, it may be difficult to solve the problem of deterioration of reliability through the implementation of the invention thereof.

### RELATED ART DOCUMENT

(Patent Document 1) Korean Patent Laid-Open Publication No. KR 2011-0002431
(Patent Document 2) Korean Patent Laid-Open Publication No. KR 2010-0032341

### SUMMARY OF THE INVENTION

An aspect of the present invention provides a multilayered ceramic electronic component capable of preventing crack generation at the time of soldering a multilayered ceramic electronic component on a PCB, or the like, to thereby improve reliability thereof and reduce a plating time at the time of forming external electrodes.

According to an aspect of the present invention, there is provided a multilayered ceramic electronic component including: a ceramic body in which a plurality of dielectric layers are multilayered; a plurality of first and second internal electrode layers formed on at least one surfaces of the dielectric layers and alternately exposed through both ends of the ceramic body in a length direction thereof; first and second adhesive layers formed on both ends of the ceramic body, electrically connected to the exposed first and second internal electrodes and formed of a conductive paste; and first and second external electrode layers formed on surfaces of the first and second adhesive layers and formed of a glass-free conductive paste.

The first and second adhesive layers may include at least one conductive metal and a glass, the conductive metal being selected from a group consisting of copper (Cu), nickel (Ni), silver (Ag), and silver-palladium (Ag—Pd).

The first and second external electrode layers may surround the first and second adhesive layers.

The first and second adhesive layers may partially surround an upper surface, a lower surface, and both side surfaces of the ceramic body, and the first and second external electrode layers may have lengths shorter than those of the first and second adhesive layers to expose the first and second adhesive layers to the outside.

The multilayered ceramic electronic component may further include a plating layer formed on the first and second external electrode layers.

According to another aspect of the present invention, there is provided a manufacturing method of a multilayered ceramic electronic component, the method including: preparing a plurality of ceramic green sheets using a ceramic slurry; forming a first or second internal electrode pattern on at least one surface of each of the plurality of ceramic green sheets so as to be alternately exposed through both ends of the multilayered ceramic electronic component; forming a multilayered body by stacking the plurality of ceramic green sheets having the first and second internal electrode patterns formed thereon; cutting the multilayered body into individual chips; forming a ceramic body by firing the cut multilayered body; forming first and second adhesive layers on both ends of the ceramic body, using a conductive paste, so as to cover a portion at which the first and second internal electrode patterns are exposed; and forming first and second external electrode layers on surfaces of the first and second adhesive layers, using a glass-free conductive paste.

In the forming of the first and second external electrode layers, the first and second external electrode layers may be formed by applying the glass-free conductive paste having a specific type onto a small portion on both ends of the ceramic body.

In the forming of the first and second external electrode layers, the first and second external electrode layers may penetrate a structure having a plurality of pores to form the first and second external electrode layers so as to have a pointed or layered surface shape.

In the forming of the first and second adhesive layers, the first and second adhesive layers may be formed by applying the conductive paste including at least one conductive metal and a glass, the conductive metal being selected from a group consisting of copper (Cu), nickel (Ni), silver (Ag), and silver-palladium (Ag—Pd), on both ends of the ceramic body.

In the forming of the first and second external electrode layers, the first and second external electrode layers may surround the first and second adhesive layers.

In the forming of the first and second adhesive layers, the first and second adhesive layers may partially surround an upper surface, a lower surface, and both side surfaces of the ceramic body, and in the forming of the first and second external electrode layers, the first and second external electrode layers may have lengths shorter than those of the first and second adhesive layers to expose the first and second adhesive layers to the outside.

The manufacturing method may further include forming a plating layer on the first and second external electrode layers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a structure of a multilayered ceramic capacitor according to an embodiment of the present invention;

FIG. 2 is a cross-sectional view taken along line A-A′ of FIG. 1; and

FIG. 3 is a cross-sectional view of line A-A′ of a multilayered ceramic capacitor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

In addition, unless explicitly described otherwise, “comprising” any components will be understood to imply the inclusion of other components but not the exclusion of any other components.

According to an embodiment of the present invention, a multilayered ceramic electronic component is provided. As an example of the multilayered ceramic electronic components according to an embodiment of the present invention, there may be a multilayered ceramic capacitor, an inductor, a piezoelectric element, a varistor, a chip resistor, a thermistor, and the like. Hereinafter, the multilayered ceramic capacitor is described as an example of the multilayered ceramic electronic product.

In addition, for convenience of description, surfaces of a ceramic body on which external electrodes are formed in a length direction (L) are termed both ends, surfaces which vertically intersect both ends in a width direction (W) are termed side surfaces, and surfaces in a thickness direction (T) are termed an upper surface and a lower surface.

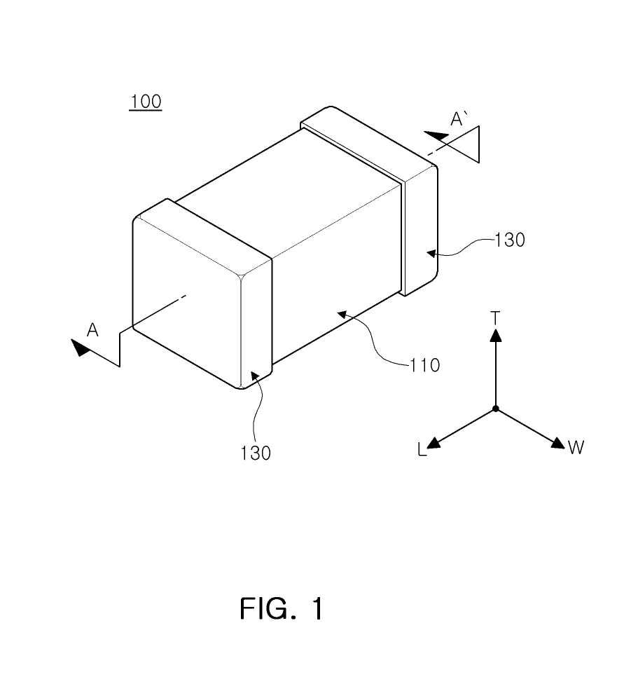

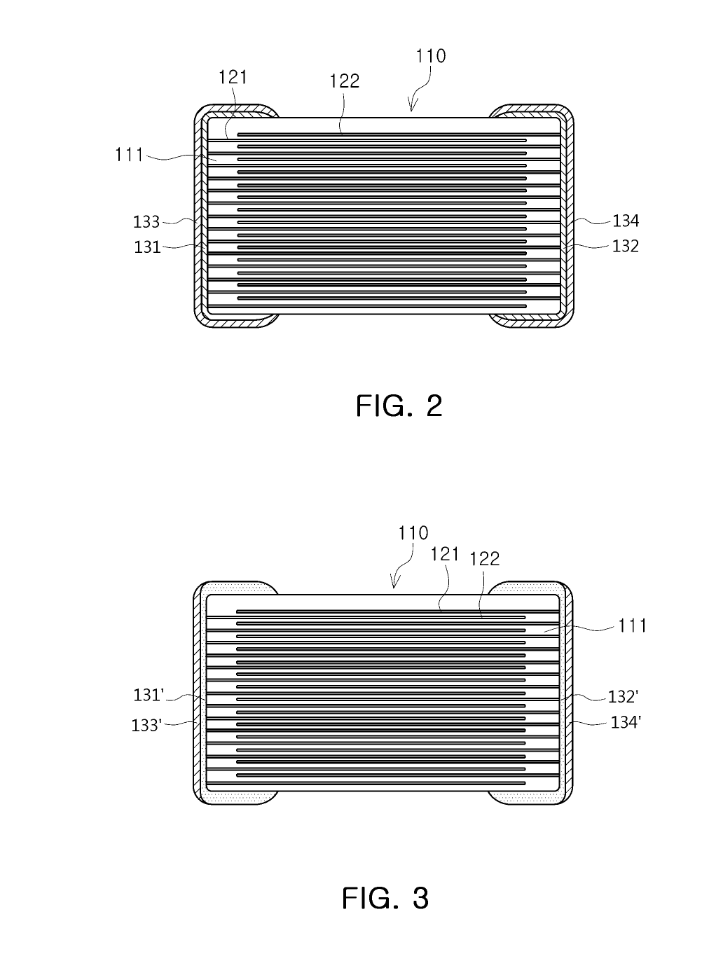

Referring to FIGS. 1 and 2, the multilayered ceramic capacitor 100 according to the embodiment of the present invention may include a ceramic body 110 in which a plurality of dielectric layers 111 are multilayered; a plurality of first and second internal electrode layers 121 and 122 formed on at least one surface of the ceramic body 110 and alternately exposed through both ends of the ceramic body 110 in a length direction of the ceramic body 110; first and second adhesive layers 131 and 132 formed on both ends of the ceramic body 110 and electrically connected to the exposed first and second internal electrodes 121 and 122, and first and second external electrode layers 133 and 134 formed on surfaces of the first and second adhesive layers 131 and 132.

The first and second adhesive layers 131 and 132 may be formed of a conductive paste, and may include at least one conductive metal and a glass material, the conductive metal being selected from a group consisting of copper (Cu), nickel (Ni), silver (Ag), and silver-palladium (Ag—Pd).

The first and second external electrode layers 133 and 134 may be formed of a glass-free conductive paste, and may include at least one conductive metal selected from a group consisting of copper (Cu), nickel (Ni), silver (Ag), and silver-palladium (Ag—Pd).

The first and second external electrode layers 133 and 134 may surround the first and second adhesive layers 131 and 132.

In addition, the first and second external electrode layers 133 and 134 may further include a plating layer of Ni/Sn formed thereon.

The ceramic body 110 may be formed by stacking the plurality of dielectric layers 111.

Here, the plurality of dielectric layers 111 configuring the ceramic body 110 are in a sintered state and may be integrated such that a boundary between adjacent dielectric layers may not be readily apparent.

In addition, the ceramic body 110 may generally have a rectangular parallelepiped form, but is not specifically limited thereto.

Further, the ceramic body 110 is not specifically limited in dimensions, but, for example, may have a size of 0.6 mm×0.3 mm, or the like, to thereby form a multilayered ceramic capacitor 100 having high capacity of 1.0 μF or more.

The dielectric layer 111 configuring the ceramic body 110 may include ceramic powder, for example, a BaTiO₃-based ceramic powder, or the like.

An example of the BaTiO₃-based ceramic powder may include (Ba₁₋ₓCaₓ)TiO₃, Ba(Ti_{1-y}Ca_{y})O₃, (Ba₁₋ₓCaₓ) (Ti_{1-y}Zr_{y})O₃, or Ba(Ti_{1-y}Zr_{y})O₃, or the like, in which Ca, Zr, or the like, is partially introduced in BaTiO₃, but the present invention is not limited thereto.

The ceramic powder may have an average particle diameter of 0.8 μm or less, more specifically, 0.05 to 0.5 μm, but the present invention is not limited thereto.

When needed, the dielectric layer 111 may further include at least one material selected from a transition metal oxide, a carbide, a rare-earth element, Mg, and Al, together with the ceramic powder.

In addition, a thickness of the dielectric layer 111 may be arbitrarily changed according to a design capacity of the multilayered ceramic capacitor.

In the embodiment of the present invention, the thickness of each dielectric layer 111 may be 1.0 μm or less, specifically 0.01 to 1.0 μm. However, the present invention is not limited thereto.

The first and second internal electrode layers 121 and 122 may be formed of a conductive paste including a conductive metal.

Here, the conductive metal may be Ni, Cu, Pd or an alloy thereof, but the present invention is not limited thereto.

The first and second internal electrode layers 121 and 122 may be internal electrode patterns printed on ceramic green sheets forming the dielectric layers 111, where the conductive paste is printed thereon through a printing method such as a screen printing method or a gravure printing method, to thus form the internal electrode patterns thereon. The ceramic green sheets having the internal electrode patterns printed thereon may be alternately multilayered and fired to thereby form the ceramic body 110.

Here, capacitance is formed in an area in which the first and second internal electrode layers 121 and 122 are overlapped.

In addition, the thickness of the first and second internal electrode layers 121 and 122 may be determined according to the use thereof. For example, when considering the size of the ceramic body 110, the thickness may be determined so as to be within a range of 0.2 to 1.0 μm. However, the present invention is not limited thereto.

FIG. 3 shows a multilayered ceramic capacitor according to another embodiment of the present invention.

Here, since structures of the ceramic body 110 and the first and second internal electrode layers 121 and 122 are the same as those of the previously described embodiment of the present invention, a specific description thereof will be omitted in order to avoid overlapping portions, and first and second adhesive layers 131′ and 132′, and first and second external electrode layers 133′ and 134′ according to another embodiment of the present invention will be described in detail.

Referring to FIG. 3, the first and second adhesive layers 131′ and 132′ may partially surround an upper surface, a lower surface, and both side surfaces of the ceramic body 110, and the first and second external electrode layers 133′ and 134′ may have lengths shorter than those of the first and second adhesive layers 131′ and 132′ to expose the first and second adhesive layers 131′ and 132′ to the outside.

Hereinafter, a manufacturing method of the multilayered ceramic capacitor 100 according to an embodiment of the present invention will be described.

A plurality of ceramic green sheets are prepared.

For forming the dielectric layer 111 of the ceramic body 110, the ceramic green sheets are produced by mixing a ceramic powder, a polymer, a solvent, and the like, to prepare a ceramic slurry, and then forming the ceramic slurry in sheets of several μm in thickness, using a doctor blade method.

Then, the conductive paste is printed on at least one surface of each of the ceramic green sheets to have a predetermined thickness, for example, 0.2 to 1.0 μm, to thereby form the first internal electrode layer 121 and the second internal electrode layer 122, respectively.

The first and second internal electrodes 121 and 122 may be formed by printing the conductive paste to form a margin portion along with edge portions of the ceramic green sheets.

Here, the first internal electrode 121 may be formed on a first ceramic green sheet of the plurality of ceramic green sheets so as to be exposed through one end of the first ceramic green sheet, and the second internal electrode 122 may be formed on a second ceramic green sheet of the plurality of ceramic green sheets, in a direction opposite to that of the first internal electrode 121 so as to be exposed through the other end of the second ceramic green sheet.

The conductive paste may be printed by using a screen printing method, a gravure printing method, or the like, and may include a metal powder, a ceramic powder, a silica (SiO₂) powder, or the like.

The average particle diameter of the conductive paste may be 50 to 400 nm, but the present invention is not limited thereto.

The metal powder may be at least one of nickel (Ni), manganese (Mn), chromium (Cr), cobalt (Co), and aluminum (Al) or an alloy thereof.

Then, the first ceramic green sheet and the second ceramic green sheet are alternately multilayered in plural, and pressurized in a multilayered direction to form the plurality of first and second ceramic green sheets. The plurality of first and second ceramic green sheets and the first and second internal electrodes 121 and 122 formed on the plurality of first and second ceramic green sheets are pressurized in a vertical direction to form a multilayered body.

Then, the multilayered body is cut to have an area corresponding to an individual multilayered ceramic capacitor to be produced as a chip, and fired at a relatively high temperature to thereby complete the ceramic body 110.

Then, the first and second adhesive layers 131 and 132 are formed on both ends of the ceramic body 110, using the conductive paste, so as to cover a portion in which the first and second internal electrode layers 121 and 122 are exposed.

Here, the first and second adhesive layers 131 and 132 may be formed by applying the conductive paste including at least one conductive metal and a glass material, the conductive metal being selected from a group consisting of copper (Cu), nickel (Ni), silver (Ag), and silver-palladium (Ag—Pd), on both ends of the ceramic body 110.

Then, the first and second external electrode layers 133 and 134 may be formed of a glass-free conductive paste on surfaces of the first and second adhesive layers 131 and 132.

The first and second external electrode layers 133 and 134 may surround the first and second adhesive layers 131 and 132.

Meanwhile, the first and second adhesive layers 131 and 132 may partially surround an upper surface, a lower surface, and both side surfaces of the ceramic body 110, and the first and second external electrode layers 133 and 134 may have lengths shorter than those of the first and second adhesive layers 131 and 132 to expose the first and second adhesive layers 131 and 132 to the outside.

The first and second external electrode layers penetrate a structure having a plurality of pores to form the first and second external electrode layers so as to have a pointed or layered surface shape.

Then, when needed, surfaces of the first and second external electrode layers 133 and 134 may be formed by a plating treatment using nickel, tin, or the like.

As set forth above, according to the embodiment of the present invention, the external electrodes of the multilayered ceramic electronic component do not have the glass material, whereby crack generation and a deterioration in performance may be prevented at the time of performing soldering on a PCB, or the like, to improve the reliability thereof.

In addition, a melted soldering may be applied without performing a pretreatment, whereby the plating time may be reduced at the time of forming the external electrodes.

While the present invention has been shown and described in connection with the embodiments, it will be apparent to those skilled in the art that modifications and variations can be made without departing from the spirit and scope of the invention as defined by the appended claims.

What is claimed is:

1. A multilayered ceramic electronic component comprising:
a ceramic body including a plurality of dielectric layers multilayered therein;
a plurality of first and second internal electrode layers formed on at least one surfaces of the dielectric layers and alternately exposed through both ends of the ceramic body in a length direction of the ceramic body;
first and second adhesive layers formed on both ends of the ceramic body, electrically connected to the exposed first and second internal electrodes, and formed of a conductive paste; and
first and second external electrode layers formed on surfaces of the first and second adhesive layers and formed of a glass-free conductive paste.

2. The multilayered ceramic electronic component of claim 1, wherein the first and second adhesive layers include at least one conductive metal and a glass, the conductive metal being selected from a group consisting of copper (Cu), nickel (Ni), silver (Ag), and silver-palladium (Ag—Pd).

3. The multilayered ceramic electronic component of claim 1, wherein the first and second external electrode layers surround the first and second adhesive layers.

4. The multilayered ceramic electronic component of claim 1, wherein the first and second adhesive layers partially surround an upper surface, a lower surface, and both side surfaces of the ceramic body, and the first and second external electrode layers have lengths shorter than those of the first and second adhesive layers to expose the first and second adhesive layers to the outside.

5. The multilayered ceramic electronic component of claim 1, further comprising a plating layer formed on the first and second external electrode layers.

6. A manufacturing method of a multilayered ceramic electronic component, the method comprising:
preparing a plurality of ceramic green sheets using a ceramic slurry;
forming a first or second internal electrode pattern on at least one surface of each of the plurality of ceramic green sheets so as to be alternately exposed through both ends of the multilayered ceramic electronic component;
forming a multilayered body by stacking the plurality of ceramic green sheets having the first and second internal electrode patterns formed thereon;
cutting the multilayered body into individual chips;
forming a ceramic body by firing the cut multilayered body;
forming first and second adhesive layers on both ends of the ceramic body, using a conductive paste, so as to cover a portion at which the first and second internal electrode patterns are exposed; and
forming first and second external electrode layers on surfaces of the first and second adhesive layers, using a glass-free conductive paste.

7. The manufacturing method of claim 6, wherein in the forming of the first and second external electrode layers, the first and second external electrode layers are formed by applying the glass-free conductive paste having a specific type onto a small portion on both ends of the ceramic body.

8. The manufacturing method of claim 6, wherein in the forming of the first and second external electrode layers, the first and second external electrode layers penetrate a structure having a plurality of pores to form the first and second external electrode layers so as to have a pointed or layered surface shape.

9. The manufacturing method of claim 6, wherein in the forming of the first and second adhesive layers, the first and second adhesive layers are formed by applying the conductive paste including at least one conductive metal and a glass, the conductive metal being selected from a group consisting of copper (Cu), nickel (Ni), silver (Ag), and silver-palladium (Ag—Pd), on both ends of the ceramic body.

10. The manufacturing method of claim 6, wherein in the forming of the first and second external electrode layers, the first and second external electrode layers surround the first and second adhesive layers.

11. The manufacturing method of claim 6, wherein in the forming of the first and second adhesive layers, the first and second adhesive layers partially surround an upper surface, a lower surface, and both side surfaces of the ceramic body, and
in the forming of the first and second external electrode layers, the first and second external electrode layers have lengths shorter than those of the first and second adhesive layers to expose the first and second adhesive layers to the outside.

12. The manufacturing method of claim 6, further comprising forming a plating layer on the first and second external electrode layers.
